(19) United States
(12) Patent Application Publication
(10) Pub. No.: US 2025/0077199 A1
(43) Pub. Date: Mar. 6, 2025

(54) DEVICE DRIVING METHOD, APPARATUS, AND ELECTRONIC DEVICE

(71) Applicant: Shanghai Gewu Zhiyuan Network Technology Co., Ltd., Shanghai (CN)

(72) Inventors: Xuebo Hong, Beijing (CN); Zhenxing Qian, Beijing (CN); Yimin Li, Beijing (CN); Dong Chen, Beijing (CN); Lixin Guan, Beijing (CN)

(21) Appl. No.: 18/820,124

(22) Filed: Aug. 29, 2024

(30) Foreign Application Priority Data
Aug. 29, 2023 (CN) 202311102898.9

(51) Int. Cl. G06F 8/41

(52) U.S. Cl. CPC G06F 8/41

(57) ABSTRACT

The present disclosure provides a device driving method, apparatus, and electronic device. The method comprises: receiving call parameters comprising a device identification, a device class, and a driving instruction of a target device; looking up a target function-class module matching the device class in at least one function-class module according to the device class and a pre-set first mapping relationship; looking up, by using the target function-class module, a target function sub-module in at least one function sub-module according to the device identification and a second mapping relationship; sending the driving instruction to the target device via the target function sub-module, to drive the target device to execute a task corresponding to the driving instruction.

### CROSS-REFERENCE TO RELATED APPLICATION(S)

This application claims priority to Chinese Application No. 202311102898.9 filed in Aug. 29, 2023, the disclosures of which are incorporated herein by reference in their entities.

### FIELD

The present disclosure relates to the technical field of driving, and particularly to a device driving method, apparatus, and electronic device.

### BACKGROUND

In the scenarios of network application such as cloud warehouse and cloud quality inspection, it is necessary to monitor the logistics conditions of warehousing in real time through the network, or the quality, surface, and appearance of displayed articles, and therefore the hardware devices to be driven have become rich and diverse, for example, displaying a picture requires use of a camera or lens module to take a picture or record a video, or weighing a displayed article requires use of a device such as a balance or electronic scale.

At present, when different hardware devices are accessed, interface standards are inconsistent, or matched parameters of the hardware devices are incompatible, which causes the hardware devices in a cloud warehouse and a cloud quality inspection institution to fail to adapt to upper-layer functions of a network system, and even fail to drive edge hardware devices, failing to meet the user's needs in the cloud warehouse and the cloud quality inspection.

### SUMMARY

In order to solve the technical problems that different devices have inconsistent interface standards and cannot be accessed to the existing cloud warehouse or cloud quality inspection platform, the present disclosure provides a device driving method, apparatus, and electronic device. Specifically, the present disclosure discloses the following technical solutions:

In a first aspect, an embodiment of the present disclosure provides a device driving method, the method being applied to a client, the client comprising at least one function-class module, each function-class module comprising at least one function sub-module, each function-class module being used for identifying a device class of a device, each function sub-module being used for driving a terminal device under the device class thereof, the terminal device driven by each function sub-module being different, the device driving method comprising:
receiving call parameters comprising a device identification, a device class, and a driving instruction of a target device;
looking up a target function-class module matching a first device class in at least one function-class module according to the device class and a pre-set first mapping relationship, the first mapping relationship being a relationship between the device class supported driving by the client and respective function-class modules;
looking up, by using the target function-class module, a target function sub-module in at least one function sub-module according to the device identification and a second mapping relationship, wherein the second mapping relationship is a relationship between each function sub-module under the target function-class module and a different device identification.
sending the driving instruction to the target device via the target function sub-module, the driving instruction being used to drive the target device to execute a task corresponding to the driving instruction.

In conjunction with the first aspect, in a possible implementation, the looking up a target function sub-module in the at least one function sub-module according to the device identification and a second mapping relationship comprises: looking up, according to the device identification, a function sub-module matching the device identification in the at least one function sub-module, as the target function sub-module.

In conjunction with the first aspect, in another possible implementation, the client further comprises a host process; the method further comprises: before receiving the call parameters sent by the host process, activating the host process; scanning a program directory of the host process and obtaining the at least one function-class module; and loading the at least one function-class module according to an interface specification and establishing the first mapping relationship.

Optionally, the interface specification is a websocket protocol interface specification.

In conjunction with the first aspect, in a further possible implementation, the client further comprises a core daemon process, and the activating the host process comprises: determining whether a process currently running has a process with the same process name as that of the host process; in response to a determination that the process currently running has a process with the same process name as that of the host process, closing the running host process, looking up to find a host process file, and activating the host process file; and in response to a determination that the process currently running does not have a process with the same process name as that of the host process, looking up and activating the host process file.

In conjunction with the first aspect, in a further possible implementation, the method further comprises: determining a function sub-module in each function-class module, and loading each function sub-module.

Furthermore, the determining a function sub-module in each function-class module comprises: polling each function sub-module; calling an export function, and obtaining a virtual function returned after the export function is called; determining whether content in the virtual function is the same as a class identified by a current function-class module; in response to a determination that the content in the virtual function is the same as a class identified by a current function-class module, determining that the current function sub-module is one function sub-module in the current function-class module.

In conjunction with the first aspect, in a further possible implementation, the at least one function-class module comprises a camera-class module, a serial port-class module and a software management-class module;
the sending a driving instruction to the target device via the target function sub-module, to drive the target device to execute a task corresponding to the driving instruction comprises:
if the target function-class module is a camera module, sending a first driving instruction to a camera via the target function sub-module, the first driving instruction being used for driving the camera to take a picture or record a video; and
if the target function-class module is a serial port-class module, sending a second driving instruction to a balance via the target function sub-module, the second driving instruction being used for driving the balance to perform a measurement operation;
if the target function-class module is a software management-class module, sending a third driving instruction to the operating system via the target function sub-module, the third driving instruction being used for activating a software management function.

In connection with the first aspect, in yet another possible implementation, the method further comprises: after pulling up the core daemon process, acquiring configuration information from a cloud; determining according to the configuration information whether the at least one function-class module and/or the at least one function sub-module needs to be updated at the client; in response to a determination that the at least one function-class module and/or the at least one function sub-module needs to be updated at the client, updating the at least one function-class module and/or at least one function sub-module by using the configuration information.

In a second aspect, embodiments of the present disclosure provide a device driving apparatus comprising:
a receiving unit configured to receive call parameters comprising: a device identification, a device class and a driving instruction of a target device;
a first lookup unit configured to look up a target function-class module matching the device class in the at least one function-class module according to the device class and a pre-set first mapping relationship, the first mapping relationship being a relationship between the device class supported driving by the apparatus and respective function-class modules;
a second lookup unit configured to look up, by using the target function-class module, a target function sub-module in the at least one function sub-module according to the device identification and a second mapping relationship, wherein the second mapping relationship is a relationship between each function sub-module under the target function-class module and a different device identification; and
a sending unit configured to send the driving instruction to the target device via the target function sub-module so as to drive the target device to execute a task corresponding to the driving instruction.

In a third aspect, the present disclosure provides an electronic device comprising: a memory and a processor, the memory and the processor being communicatively connected to each other, the memory having stored computer program instructions therein, the processor performing the device driving method in the first aspect or any implementation corresponding thereto by executing the computer program instructions.

In addition, the present disclosure provides a computer readable storage medium having stored thereon computer instructions for causing a computer to perform the device driving method in the first aspect or any implementation corresponding thereto.

According to the device driving method and apparatus and the electronic device of the present disclosure, when a device is accessed, an access standard is uniformly provided to the outside through the host process; call parameters such as a device name, a device class, and a driving instruction input by a user are issued to a target function-class module to be driven, the target function-class module then finds a target function sub-module of a specific drivable device according to these call parameters, and finally, the target function sub-module issues a driving instruction to a terminal device connected thereto so as to realize calling on the target terminal device. The method solves a problem about device compatibility, realizes the driving and calling of an edge device, and satisfies the user's calling demands in cloud warehouse or cloud quality inspection institution.

### BRIEF DESCRIPTION OF THE DRAWINGS

In order to more clearly describe technical solutions in specific embodiments in the present disclosure or the prior art, figures to be used to describe the specific embodiments or prior art will be introduced briefly. Obviously, the figures described below illustrate some embodiments of the present disclosure. Those having ordinary skill in the art may also obtain other figures according to these figures without making any inventive efforts.

FIG. 1 is an architecture diagram of a cloud quality inspection service scenario according to an embodiment of the present disclosure;

FIG. 2 is a block diagram of a drive structure of a client according to an embodiment of the present disclosure;

FIG. 3 is a flow chart of a device driving method according to an embodiment of the present disclosure;

FIG. 4 is a signaling flow chart of a device driving method according to an embodiment of the present disclosure;

FIG. 5 is a flow chart for loading functional modules according to an embodiment of the present disclosure.

FIG. 6 is another flow diagram for loading functional modules according to an embodiment of the present disclosure.

FIG. 7 is a block diagram of a device driving apparatus according to an embodiment of the present disclosure;

FIG. 8 is a schematic diagram of a hardware structure of an electronic device according to an embodiment of the present disclosure.

### DETAILED DESCRIPTION

Technical solutions in embodiments of the present disclosure will be described clearly and completely with reference to figures in the embodiments of the present disclosure to make the objectives, technical solutions, and advantages of embodiments of the present disclosure more apparent. Obviously, the described embodiments are partial embodiments of the present disclosure rather than all embodiments. Based on the embodiments of the present disclosure, all other embodiments obtained by a person skilled in the art without making any inventive effort fall within the extent of protection of the present disclosure.

First, application scenarios of the technical solutions provided by the embodiments of the present disclosure are described.

The technical solutions of embodiments of the present disclosure are applied to a network service system of a cloud warehouse or a cloud quality inspection institution. The network service system may provide services such as streaming display, weighing, quality inspection, and warehouse logistics monitoring for some articles, so as to meet the user's demands such as cloud-online real-time monitoring and displaying.

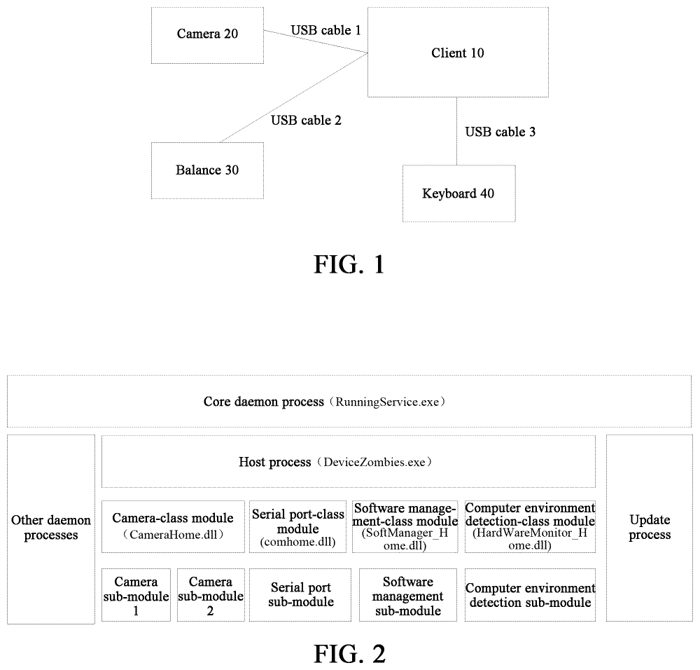

Referring to FIG. 1 which illustrates an architecture diagram of a cloud quality inspection service scenario according to an embodiment of the present disclosure, the scenario comprises: a client 10, a camera 20, a balance 30, and a keyboard 40. The client 10 is connected to other devices via a USB cable, for example, the client 10 is connected to the camera 20 via a USB cable 1, connected to the balance 30 via a USB cable 2, and connected to the keyboard 40 via a USB cable 3.

The client 10 may be a Warehouse Management System (WMS) or may be a terminal device. Specifically, the terminal device comprises but is not limited to an intelligent terminal, a notebook computer, a tablet computer, a Personal Computer (PC), a Personal Digital Assistant (PDA), a foldable terminal, a User Equipment (UE), etc., and embodiments of the present application do not limit the specific device form of the terminal device. In addition, the above various terminal devices are installed with an Android system, a Windows system, etc.

The camera 20 has a photographing function, and may perform functions such as photographing and video recording on an article to be displayed or monitored; and the camera 20 comprises but is not limited to a camera, a lens module, or a camera module. The balance 30 has a weighing function and may be used to measure the weight of an article. Alternatively, the balance 30 may be a small electronic scale, a weigh scale, etc. The keyboard 40 is an input device connected to the terminal device 10 via the USB cable 3, and is used for inputting instructions and the like to the terminal device 10.

It needs to be noted that the camera 20, the balance 30, and the keyboard 40 may be collectively referred to as another terminal device with respect to the client 10.

It should be understood that the number of the devices in the above system may be one or more, such as a plurality of PCs, notebook computers, two or more cameras and balances etc., to which the present embodiment is not limited. In addition, the above system or platform architecture may further include other hardware devices, such as display screens, smart screens, speakers, microphones, etc.

Since the interface functions between the client 10 and other hardware devices in the above-mentioned platform architecture are incompatible, or the hardware access standards of different hardware devices, such as a camera, a balance, etc., are different, these terminal devices cannot quickly access the network service system/platform, thereby causing failure to drive the hardware devices to complete corresponding functions.

In order to solve the technical problem, the technical solution provided by the present embodiment takes a client as a starting point, and provides different hardware devices with functions such as an automatic software upgrade, an automatic daemon sub-process, and a pluggable plug-in interface, and abstracts these functions as different devices and provides a uniform interface to the outside so as to improve compatibility between different hardware devices, satisfying user's demands and improving user experience.

Hereinafter, embodiments of the present disclosure will be described in detail.

Referring to FIG. 2, it illustrates a block diagram of a driving structure of a client according to the present embodiment of the invention. A Windows operating system is configured on the client, which comprises the following functional modules:

(1) A core daemon process for performing a daemon operation according to one or more preset configuration items and for different processes.

The core daemon process is a process of RunningService.exe, and the process file of RunningService.exe is a system process defined by the Windows operating system and is described as a service and controller application program. It mainly functions to be responsible for running and ending system services.

(2) A host process for loading at least one function-class module of a lower layer, automatically establishing a WebSocket server, and providing an interface in a uniform format to the outside.

The WebSocket server is a TCP application that is responsible for listening to any port on the server that follows a specific protocol. The host process is also referred to as a pluggable plug-in host process because it may provide a uniform format interface to enable the plug-in and unplug-in of different hardware devices/plug-ins.

Optionally, the pluggable plug-in host process is DeviceZombie.exe.

(3) At least one function-class module each being responsible for identifying a device class of a device and connecting downwardly one or more function sub-modules and calling one or more function sub-modules. In addition, each function-class module may also provide a uniform interface to the host process.

As shown in FIG. 2, at least one function-class module of a client comprises: a camera-class module (Camera Home.dll), a serial port-class module (comhome.dll), a software management-class module (SoftManager Home.dll), and a computer environment monitoring-class module (HardwareMonitor_Home.dll), etc.

The camera module is used for providing and docking a camera sub-module, for example, in FIG. 2, being responsible for calling two camera function sub-modules, which are respectively a camera sub-module 1 (CameraX.dll) and a camera sub-module 2 (USB Camera.dll). The two camera sub-modules are respectively responsible for driving camera devices of different brands/models/names, for example, the camera sub-module 1 is responsible for driving the camera 1, such as a camera; the camera sub-module 2 is responsible for driving the camera 2, such as a single lens reflex camera or the like.

(4) At least one function sub-module for driving a specific terminal device, and controlling the terminal device to execute a corresponding action according to an instruction of a caller.

The terminal device comprises the above-mentioned camera 20, balance 30, and keyboard 40, etc., and may further comprise other devices or unit modules, such as a certain software module in an operating system, etc., which is not limited in the present embodiment.

In the example as shown in FIG. 2, the at least one function sub-module comprises: a camera sub-module, a serial port sub-module, a software management sub-module, and a computer environment monitoring sub-module, etc.

The serial port-class module is used for docking a serial port sub-module (Comhome.dll), and the serial port sub-module (Comhome.dll) may directly drive a balance device; the software management-class module is used for calling a software management sub-module (SoftManager.dll), and the software management sub-module (SoftManager.dll) may be a certain functional module used for managing software on a computer, such as a certain software master, a certain management software, etc. The computer environment monitoring-class module is used to call the computer environment detection submodule (HardWare Monitor_Home.dll). Optionally, the computer environment detection submodule comprises, but is not limited to, for example, some security guards, or some scanning software, etc.

Optionally, the above-mentioned camera sub-module 1 is used for docking the camera 1, the camera sub-module 2 is used for docking the camera 2, and the above at least one function-class module controls the hardware to complete corresponding operations by docking one or more multifunction sub-modules so that each class sub-module executes instructions of a user (or a caller).

(4) An upgrade process is used to automatically detect the updated information and upgrade the files/software in the list. Alternatively, one client upgrade process is clientUpgrade Program.exe.

In addition, other daemon process modules may be included in the drive structure framework shown in FIG. 2, and these modules may be used for other processes responsible for the service layer, which is not limited in the present embodiment.

The method according to the present embodiment is described in detail below.

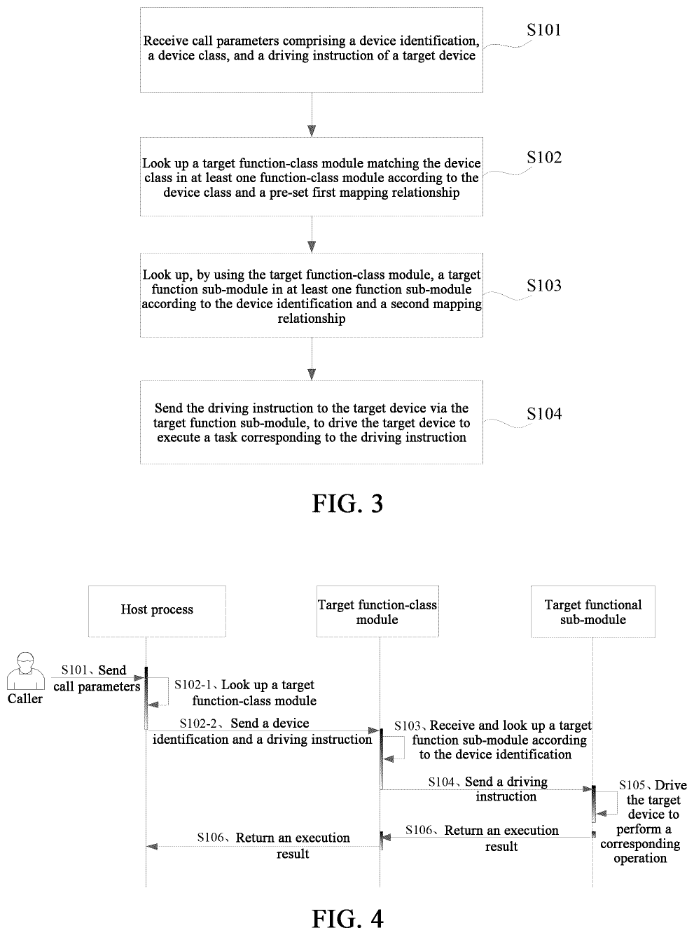

Referring to FIG. 3, there is provided a device driving method according to the present embodiment, and the method may be applied to a client, wherein the client may be the client 10 as shown in FIG. 1, and the client 10 comprises a host process, at least one function-class module and at least one function sub-module, etc. Specifically, reference may be made to the structural framework shown in FIG. 2 for the structure of the client.

The device driving method comprises the following steps:

Step S101: receiving call parameters, wherein the call parameters comprise: a device identification, a device class, and a driving instruction of a target device, etc.

The call parameters may be generated by a series of instructions input by a caller/user on a client, for example, the caller (user) needs to call a certain hardware device, for example, call the camera 1 to perform a photographing operation, then in the configured call parameters, the device identification of the target device is the camera 1, the device class is a camera-class of “camera”, and the driving instruction may be to drive the camera 1 to photograph an article in the current picture.

Additionally, the device identification of the target device comprises, but is not limited to, a device name, a device ID, a device brand, a device model, etc.

The device class is used for indicating a device class to which a target device belongs, for example, the device class of the camera 1 is a camera class; the device class of the balance is a serial port class; a device class of some management software may be a software management class.

Step S102: looking up a target function-class module matching the device class in at least one function-class module according to the device class and a pre-set first mapping relationship.

The first mapping relationship is a relationship between device classes supported driving by the client and respective function-class modules. The first mapping relationship may be generated when the system activates loading.

The device classes supported driving by the client include, but are not limited to, the aforementioned camera class, serial port class, management software class, and other predefined device classes. The above at least one function-class module as shown in FIG. 2 comprises a camera-class module (Camera Home.dll), a serial port-class module (comhome.dll), a software management-class module (SoftManager Home.dll), and a computer environment monitoring-class module (HardwareMonitor_Home.dll).

The first mapping relationship comprises at least one of the following relationships:
a mapping relationship between a camera-class module (Camera Home.dll) and a camera;
a mapping relationship between a serial port-class module (comhome.dll) and a balance;
a mapping relationship between a software management-class module (SoftManager Home.dll) and software management;
a mapping relationship between a computer environment monitoring-class module (HardwareMonitor_Home.dll) and environment monitoring software.

It should be understood that if other terminal devices such as a microphone, speaker, etc. are also included, the first mapping relationship may also include, for example: a mapping between the serial port-class module (comhome.dll) and a speaker/microphone.

The above-mentioned step S102 specifically comprises: if the first device class is the camera, looking up in the aforementioned first mapping relationship to find that the function class module associated with the “camera” class is the “camera-class module (Camera Home.dll)”, and then determining the first function-class module is the camera-class module (Camera Home.dll).

Step S103: using a target function-class module to look up a target function sub-module in the at least one function sub-module according to the device identification and a second mapping relationship.

The second mapping relationship is a relationship between each function sub-module under the target function-class module and different device identifications. For example, for the camera-class module, it comprises a camera sub-module 1 and a camera sub-module 2, wherein the camera sub-module 1 may drive a camera and the camera sub-module 2 may drive a single lens reflex camera, and then establishing the second mapping relationship includes: camera sub-module 1—camera; camera sub-module 2—single lens reflex camera.

Specifically, the target function-class module is used to look up a function sub-module matching the device identification in at least one function sub-module, as the target function sub-module.

For example, the camera-class module (Camera Home.dll) looks up a camera sub-module with the device name being “camera 1” in two camera function sub-class modules included therein, and after the lookup, determines that the function sub-module having the second mapping relationship with the camera 1 is the camera sub-module 1, namely, determines that the target function sub-module is the camera sub-module 1.

In the present example, the camera sub-module 1 is a cameraX.dll module which may be used for driving a cameraX; the camera sub-module 2 is a USBCamera.dll module that may be used to drive a USBCamera.

Step S104: sending, by the target function sub-module, a driving instruction to the target device, to drive the target device to execute a task corresponding to the driving instruction.

The driving instruction may be generated by the above step S101, and is transmitted to the target function sub-module via a host process and a target function-class module; after receiving the driving instruction, the target function sub-module drives a corresponding device to activate and execute a cloud warehouse inspection operation, and returns an operation result to the client.

Specifically, when the target functional module is a camera module, a first driving instruction is sent to the camera via the target function sub-module, and the first driving instruction is used for driving the camera to take a picture or record a video. In the present example, the camera sub-module 1 drives the cameraX to take a picture of an article in the current picture, and transmits the taken picture back to the client to achieve the drive and control of the cameraX.

Alternatively, when the target functional module is a serial port module, a second driving instruction is sent to a balance via the target function sub-module, wherein the first driving instruction is used for driving the balance to perform a measurement operation.

Alternatively, when the target function-class module is a software management-class module, a third driving instruction is sent to the operating system via the target function sub-module, wherein the third drive instruction is used for activating a management function of the software.

According to the method provided by the present embodiment, when a device is accessed, an access standard is uniformly provided to the outside through the host process; call parameters such as a device name, a device class and a driving instruction input by a user are issued to a target function-class module to be driven, the target function-class module then finds a target function sub-module of a specific drivable device according to these call parameters, and finally, the target function sub-module issues a driving instruction to a terminal device connected thereto so as to realize calling on the target terminal device. The method solves a problem about device compatibility, realizes the driving and calling of an edge device, and satisfies the user's calling demands in cloud warehouse or cloud quality inspection institution.

Referring to FIG. 4, a signaling flow chart of a device driving method is provided on the basis of the above-mentioned embodiment, and the method comprises:
after the client boots up, the core daemon module (RunningService.exe) pulls up the host process.

Step S101: when a caller's click operation on a client is received, a self-defined software (e.g., WMS warehousing client) is used to send a call parameter to a host process via a preset port.

Reference may be made to step S101 in the previous embodiment for a detailed procedure. No detailed description will be presented any more here.

Step S102-1: the host process receives the call parameter, and looks up a target function-class module in a pre-configured first mapping relationship according to the device class in the call parameter. The detailed search process is found in the depictions of step S102 in the previous embodiment.

The call parameter comprises a driving instruction for driving the target device to perform a warehouse inspection operation, such as photographing, weighing, scanning monitoring, and so on.

Step S102-2: the host process sends the device identification and driving instruction to the target function-class module.

Step S103: after receiving the device identification and driving instruction, the target function-class module determines a target function sub-module from at least one function sub-module according to the device identification, the target function sub-module having a second mapping relationship with the device identification of the target device.

For example, the camera-class module (camera Home.dll) looks up the function sub-module in the second mapping relationship as camera sub-module 1 (camera X.dll) according to the device name “camera X”. The specific lookup process may be found in the above description of step S103 of the previous embodiment.

Step S104: the target function-class module sends a driving instruction to the target function sub-module. The driving instruction comprises an action instruction and a device identification, such as a USB identification, USB1, etc.

Step S105: after receiving the driving instruction, the target function sub-module drives the target device to perform a corresponding operation.

Step S106: the target function sub-module returns an execution result of the target device to the target function-class module, and the target function-class module returns the execution result to the host process, and finally feeds back the execution result to the caller/user, and displays the execution result on a display interface of the client, such as taking a picture, a weight measured by the balance, and a running condition of the software monitored after the management software is activated.

Optionally, in some embodiments, the above-mentioned step S101, before receiving the call parameter sent by the host process, the method further comprises: activating the host process; scanning a program directory of the host process to obtain at least one function-class module; loading the at least one function-class module according to an interface specification, and establishing the first mapping relationship after loading.

The interface specification is a websocket protocol interface specification, and at least one function-class module is monitored and loaded using a websocket server under the websocket protocol interface specification.

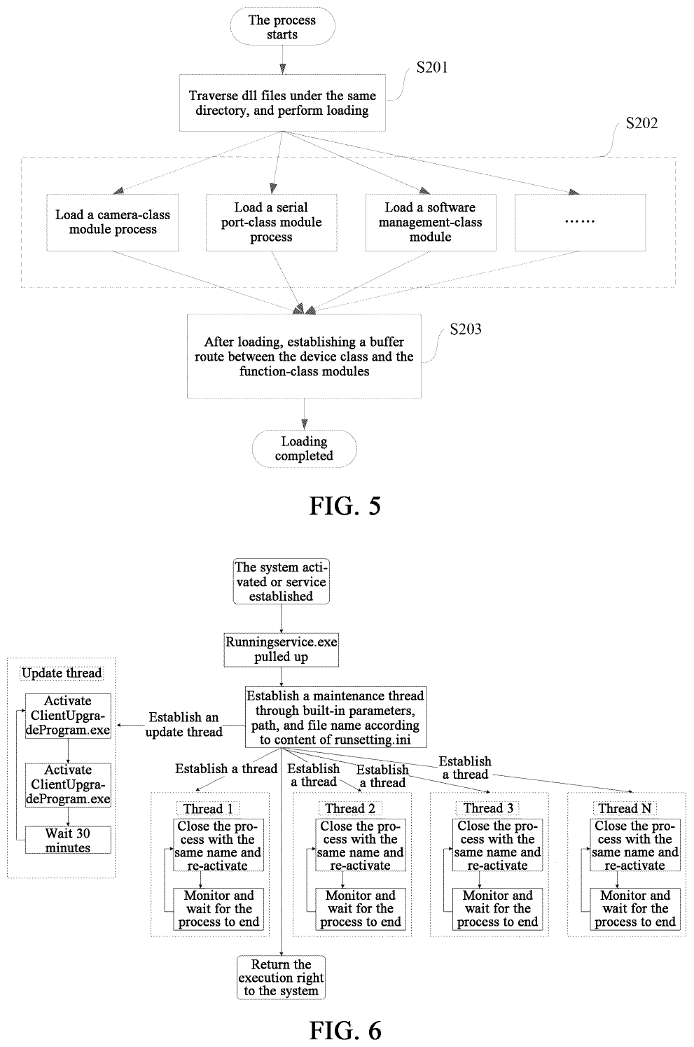

Referring to FIG. 5, the core daemon activates the host process. After the installation of the core daemon is completed, the core daemon first gets a running opportunity and registers itself as a service to run with a SYSTEM right. This specifically includes:

Step S201: the host process, after being activated, traverses a dll file under the same directory, namely, scans a dll module file (such as a function-class module) in a directory (a first-level directory) where a scanning program is located.

Step S202: the host process loads according to the interface specification, and loads at least one function-class module, including the aforementioned camera-class module (Camera Home.dll), serial port-class module (comhome.dll), software management-class module (SoftManager Home.dll), etc.

Step S203: after loading, after acquiring a device class (or a device class name), establishing a buffer route between each device class and each function-class module, namely, establishing at least one first mapping relationship.

The buffer route comprises a mapping relationship between the target function-class module and the device class of the target device.

Furthermore, as shown in FIG. 6, during the above activation of the host process, a Runningservice.exe thread is pulled up; a maintenance thread is established according to at least one pre-set configuration item such as runsetting.int content, by means of built-in parameters including a path and a file name process, for all processes (thread 1 to thread N), a closing operation is performed first to close the same process names and avoid remnant of processes, and then an activation operation is performed with a configured right, for example, monitoring via a process handle, and guarding to activate the host process.

The threads 1-N comprise a host process. With the host process being taken as an example, the activating process specifically comprises:
Step 1: determining whether a process which is currently running has a process with the same process name as that of the host process (DeviceZombie);
Step 2: if so (the process with the same process name as that of the host process exists), closing the running host process of DeviceZombie.exe and finding the host process of DeviceZombie.exe file and activating the host process of the DeviceZombie.exe file.

Step 3: if not (the process with the same process name as that of the host process does not exist), looking up and activating the host process of the DeviceZombie.exe file, and then activating the host process.

After the activation, the host process of DeviceZombie.exe is monitored, and if it is monitored that the running of the host process ends, the flow skips to the above-mentioned “step 1”, to continuously activate and monitor the host process.

Further, one implementation is establishing a WebSocket server and monitoring the host process through the WebSocket server. Specifically, the caller sends WebSocket information with a fixed format, then issues an instruction to each function-class module according to the buffer route established according to the device class in the above-mentioned step S203, and loads each function-class module. Here, the host process is monitored through a preset port (such as a 17888 port) of the WebSocket server, and the foregoing steps S101 to S104 are performed.

In addition, Step S202 further comprises: determining a function sub-module in each of the function-class modules, and loading each of the function sub-modules.

Specifically, one implementation is polling each of the function sub-modules, calling an export function, and obtaining a virtual function returned after the export function is called, for example, a function-class module returns a piece of class information after the export function is called; determining whether the piece of class information contains a virtual function of a class, namely, determining whether the content in the virtual function is the same as the class identified by the current function-class module. In response to a determination that the content in the virtual function is the same as the class identified by the current function-class module, it is determined that the current function sub-module is a function sub-module in the current function-class module. In response to a determination that the content in the virtual function is not the same as the class identified by the current function-class module, it is determined that the current function sub-module is not a function sub-module included by the current function-class module.

The export function called is a CreateInstance export function, and the class information returned by calling the CreateInstance export function is an object address, which refers to an address of the function-class module.

Furthermore, if a virtual function of a class is contained, a determination is made as to whether a character string (namely, a device class) returned by the virtual function of the class is null; if it is not null, a determination is made as to whether the character string is of the same type as a current class loader (such as a camera-class module); if it is the same, determination is made that the current function sub-module is a sub-module of the current function-class module; for example, it is determined that the camera submodule 1 (cameraX.dll) is a submodule of the camera-class module (Camera Home.dll). Similarly, function sub-modules corresponding to other function-class modules are also found out by the method; after all the function-class modules are polled, the host process writes all the device classes and object addresses (various function-class modules) supported driving by the client into a mapping table to generate the first mapping relationship.

In the present embodiment, the host process is loaded by pulling up the core daemon process, and the scanning of at least one function-class module in a directory where the host process program is located is activated, so as to establish a mapping relationship between the function-class modules and the device classes, and an access standard is uniformly provided externally through the host process, for example, each function-class module is loaded using a 17888 port, so as to realize calling each function sub-module of the lower layer.

According to the method, when the system is activated, the terminal device accessed by the current machine may be dynamically loaded through a pluggable host process, and may be accessed to the cloud warehouse and the cloud quality inspection system after the terminal device module is placed in. In addition, when the terminal device is accessed, the core daemon process RunningService is used to daemon the hardware device process to ensure that the device process may be quickly reset in the case of abnormal operation.

In yet another embodiment, the above method further comprises an upgrade process. Specifically, the method comprises: after pulling up the core daemon process, acquiring configuration information from a cloud, detecting the update configuration of the cloud, and determining according to the configuration information whether the at least one function-class module and/or at least one function sub-module needs to be updated at the client; in response to a determination that the at least one function-class module and/or at least one function sub-module needs to be updated at the client, it is discovered after detection that the update is needed, updating the at least one function-class module and/or at least one function sub-module by using the configuration information.

Specifically, the activation is performed by the core daemon process at a preset time, for example, every 30 minutes (configurable); after the activation, the update configuration of the cloud is detected; and the update action is executed if it is discovered that the update is needed.

After the update action is completed, since a window cannot be displayed under the SYSTEM right, a pop-up window is executed in a right-reducing manner to query whether the user needs to reset; after the user chooses, the choice passes through a pipeline and then is transmitted back to the process under the SYSTEM right. If the user chooses “YES”, the core daemon process is reset and therefore all processes in the whole drive are reset.

Optionally, the result further comprises other daemon processes, which are activated and guarded by the core daemon process and formed by the service layer and decided by the actual scenario, which is not limited in the present embodiment.

In the present embodiment, there is also provided a device driving apparatus for implementing the above-described embodiments and alternative embodiments, the description having been stated will not be repeated herein. As used below, the term “module” may implement a combination of software and/or hardware for a predetermined function. Although the apparatus described in the following embodiments is preferably implemented by software, it is also possible and envisageable that the apparatus may be implemented by hardware, or a combination of software and hardware.

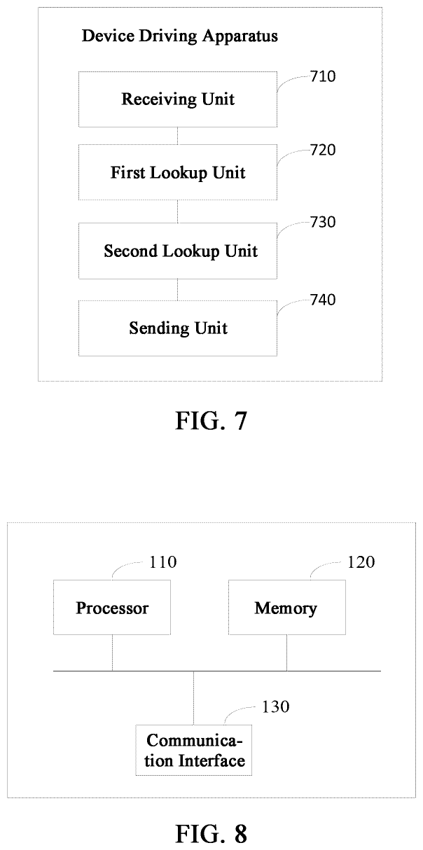

As shown in FIG. 7, the device driving apparatus comprises: a receiving unit 710, a first lookup unit 720, a second lookup unit 730, and a sending unit 740. In addition, the device driving apparatus may include other more or fewer units or modules.

Specifically, the receiving unit 710 is configured to receive call parameters comprising: a device identification, a device class, and a driving instruction of a target device.

The first lookup unit 720 is configured to look up a target function-class module matching the device class in the at least one function-class module according to the device class and a pre-set first mapping relationship, the first mapping relationship being a relationship between the device class supported driving by the apparatus and respective function-class modules.

The second lookup unit 730 is configured to look up, by using the target function-class module, a target function sub-module in at least one function sub-module according to the device identification and a second mapping relationship, wherein the second mapping relationship is a relationship between each function sub-module under the target function-class module and a different device identification.

The sending unit 740 is configured to send a driving instruction to the target device via the target function sub-module so as to drive the target device to execute a task corresponding to the driving instruction.

Optionally, in a specific implementation, the second lookup unit 730 is specifically used to look up a function sub-module matching the device identification in the at least one function sub-module according to the device identification, as the target function sub-module.

Optionally, in another specific implementation, the apparatus further comprises a processing unit, which is not shown in FIG. 7, and which is configured to activate a host process, scan a program directory of the host process and obtain the at least one function-class module; and load the at least one function-class module according to an interface specification and establish the first mapping relationship.

Optionally, in yet another specific implementation, the apparatus further comprises a core daemon unit configured to determine whether a process currently running has a process with the same process name as that of that host process; in response to a determination that the process currently running has a process with the same process name as that of that host process, close the running host process, look up to find a host process file, and activate the host process file; in response to a determination that the process currently running does not have a process with the same process name as that of that host process, look up and activate the host process file.

Optionally, in yet another specific implementation, the above-mentioned processing unit is further configured to poll each of the function sub-modules; call an export function, and obtain a virtual function returned after the export function is called; determine whether content in the virtual function is the same as a class identified by the current function-class module; in response to a determination that the content in the virtual function is the same as a class identified by the current function-class module, determine that the current function sub-module is one function sub-module in the current function-class module.

Optionally, the apparatus further comprises an update unit, not shown in FIG. 7, which is an upgrade process module (ClientUpgrade Program.exe).

The receiving unit 710 is further configured to acquire configuration information from a cloud; the processing unit is further configured to determine whether the at least one function-class module and/or the at least one function sub-module needs to be updated at the client according to the configuration information. The update unit is configured to update at least one function-class module and/or at least one function sub-module using the configuration information.

It should be noted that the functions of the receiving unit 710, the first lookup unit 720, the second lookup unit 730 and the sending unit 740 may be implemented by the core daemon process, the host process, the at least one function-class module and the at least one function sub-module as shown in FIG. 2.

The apparatus according to the present embodiment comprise the following advantages:

Firstly, when a device is accessed, an access standard is uniformly provided to the outside through the host process; call parameters such as a device name, a device class, and a driving instruction input by a user are issued to a target function-class module to be driven, the target function-class module then finds a target function sub-module of a specific drivable device according to these call parameters, and finally, the target function sub-module issues a driving instruction to a terminal device connected thereto so as to realize calling on the target terminal device, and satisfy the user's calling demands in cloud warehouse or cloud quality inspection institution.

Secondly, when the system is activated, the device accessed by the current machine may be dynamically loaded through the host process, and may be accessed to a system environment such as the cloud warehouse and the cloud quality inspection institution after the device module is placed in.

Thirdly, after the device is accessed, the core daemon process is used to daemon the device process to ensure that the device process may be quickly reset in the case of abnormal operation.

It should be understood that the device driving apparatus in the present embodiment is presented in the form of a functional module, where the module refers to an ASIC circuit, a processor executing one or more software or fixed programs, a memory, and/or other devices that may provide the above functions.

Embodiments of the present disclosure further provide an electronic device having the device driving apparatus shown in FIG. 7 described above, wherein the electronic device may be the client of the foregoing embodiments.

Referring to FIG. 8, FIG. 8 is a schematic structural diagram of an electronic device according to an alternative embodiment of the present application. As shown in FIG. 8, the electronic device comprises: one or more processors 110, a memory 120, and a communication interface 130 connecting the components and including a high-speed interface and a low-speed interface. The components are communicatively coupled to each other using different buses and may be mounted on a common motherboard or otherwise as desired.

The processor 110 may be a central processor, a network processor, or a combination thereof. The processor 110 may further include a hardware chip. The hardware chip may be an application specific integrated circuit, a programmable logic device, or a combination thereof. The programmable logic device may be a complex programmable logic device, a field programmable gate array, a general-purpose array logic, or any combination thereof. The memory 120 stores instructions executable by the at least one processor 110 to cause the at least one processor 110 to perform the device driving method shown in the above embodiments.

The memory 120 may comprise a program storage region and a data storage region, wherein the program storage region may store an operating system and an application program needed by at least one function; the storage data region may store data or the like created according to the use of the electronic device. In addition, memory 120 may include a high-speed random access memory and may also include a non-transitory memory such as at least one magnetic disk storage device, a flash memory device, or other non-transitory solid state storage device. In some alternative embodiments, the memory 120 may optionally include a memory disposed remotely with respect to the processor 110. The remote memory may be connected to the electronic device via a network. Examples of such networks include, but are not limited to, the Internet, intranets, local area networks, mobile communication networks, and combinations thereof.

The memory 120 may include a volatile memory, e.g., a random access memory; the memory may also comprise a non-volatile memory, for example, a flash memory, a hard disk or a solid-state hard disk; the memory 120 may also comprise a combination of the above types of memories.

In addition, the communication interface 130 of the electronic device is used for communicating with other devices or communication networks.

In the present embodiment, the electronic device may be a terminal device such as a PC, a notebook computer, a mobile phone terminal, etc.

Furthermore, the present application further provides a computer storage medium, wherein the computer storage medium may store a program, which when executed may comprise some or all of the steps of the embodiments of the device driving method according to the present application. The storage medium may be a magnetic disk, an optical disk, a Read-Only Memory (ROM) or a Random Access Memory (RAM), etc.

In the embodiments described above, all or part may be implemented by software, hardware, firmware, or any combination thereof. When implemented by software, it may be implemented in whole or in part in the form of a computer program product.

The computer program product comprises one or more computer instructions. The computer program, when loaded and executed by a computer, produces a flow or function according to the above embodiments of the present application in whole or in part. The computer may be a general-purpose computer, a special-purpose computer, a computer network, or other programmable devices.

The computer instructions may be stored in a computer-readable storage medium or transmitted from one computer-readable storage medium to another computer-readable storage medium. For example, the computer instructions may be transmitted from a network device, computer, server, or data center to another device, computer, or server in a wired or wireless manner.

The same or similar parts between embodiments of the description may be known by referring to one another. In particular, an embodiment of a device interconnecting apparatus is described relatively simple because it is substantially similar to the method embodiment, and relevant parts of the apparatus embodiment are known by referring to the depictions of the method embodiment.

It will be apparent to those skilled in the art that the techniques of the embodiments of the present application may be implemented by software plus a necessary general-purpose hardware platform. Based on such an understanding, the technical solutions in the embodiments of the present application in essence, or the parts thereof which make contribution over the prior art, may be embodied in the form of a software product. The computer software product may be stored in a storage medium, such as a ROM/RAM, a magnetic disk, an optical disk, etc. and comprise a plurality of instructions to cause a computer device, which may be a personal computer, a server, or a network device, etc. to perform the method described in various embodiments or parts of the embodiments of the present application.

In addition, in the description of the present application, “plurality” means two or more than two unless otherwise specified. In addition, in order to facilitate a clear description of the technical solutions of the embodiments of the present application, the words such as “first” and “second” are used in the embodiments of the present application to distinguish the same or similar items that have substantially the same function and effect. It will be understood by those skilled in the art that the words such as “first” and “second” do not limit the number and order of execution, and that the words such as “first” and “second” do not mean the terms modified by them must be different.

Although the embodiments of the present application have been described with reference to figures, those skilled in the art can make various modifications and variations without departing from the spirit and scope of the present application. Such modifications and variations are intended to fall within the scope defined by the appended claims.

I/We claim:

1. A device driving method, wherein the method is applied to a client, the client comprises at least one function-class module, each function-class module comprises at least one function sub-module, each function-class module is used for identifying a device class of a device, each function sub-module is used for driving a terminal device under the device class thereof, and the terminal device driven by each function sub-module is different, the method comprising:
receiving call parameters comprising a device identification, a device class, and a driving instruction of a target device;
looking up a target function-class module matching the device class in the at least one function-class module according to the device class and a pre-set first mapping relationship, the first mapping relationship being a relationship between the device class supported driving by the client and respective function-class modules;
looking up, by using the target function-class module, a target function sub-module in the at least one function sub-module according to the device identification and a second mapping relationship, the second mapping relationship being a relationship between each function sub-module under the target function-class module and a different device identification; and
sending the driving instruction to the target device via the target function sub-module, to drive the target device to execute a task corresponding to the driving instruction.

2. The method according to claim 1, wherein the looking up a target function sub-module in the at least one function sub-module according to the device identification and a second mapping relationship comprises:
looking up, according to the device identification, a function sub-module matching the device identification in the at least one function sub-module, as the target function sub-module.

3. The method according to claim 1, wherein the client further comprises a host process; the method further comprises: before receiving the call parameters,
activating the host process;
scanning a program directory of the host process and obtaining the at least one function-class module; and
loading the at least one function-class module according to an interface specification and establishing the first mapping relationship, wherein the interface specification is a websocket protocol interface specification.

4. The method according to claim 3, wherein the client further comprises a core daemon process, and the activating the host process comprises:
determining whether a process currently running has a process with the same process name as that of the host process;
in response to a determination that the process currently running has a process with the same process name as that of the host process, closing the running host process, looking up to find a host process file, and activating the host process file; and
in response to a determination that the process currently running does not have a process with the same process name as that of the host process, looking up and activating the host process file.

5. The method according to claim 3, wherein the method further comprises: determining a function sub-module in each function-class module, and loading each function sub-module;
the determining a function sub-module in each function-class module comprises:
polling each function sub-module;
calling an export function and obtaining a virtual function returned after the export function is called;
determining whether content in the virtual function is the same as a class identified by a current function-class module; and
in response to a determination that the content in the virtual function is the same as a class identified by a current function-class module, determining that the current function sub-module is a function sub-module in the current function-class module.

6. The method according to claim 1, wherein the at least one function-class module comprises a camera-class module, a serial port-class module, and a software management-class module;
the sending a driving instruction to the target device via the target function sub-module, to drive the target device to execute a task corresponding to the driving instruction comprises:
if the target function-class module is a camera module, sending a first driving instruction to a camera via the target function sub-module, the first driving instruction being used for driving the camera to take a picture or record a video;
if the target function-class module is a serial port-class module, sending a second driving instruction to a balance via the target function sub-module, the second driving instruction being used for driving the balance to perform a measurement operation; and
if the target function-class module is a software management-class module, sending a third driving instruction to the operating system via the target function sub-module, the third driving instruction being used for activating a software management function.

7. The method according to claim 1, wherein the method further comprises:
acquiring configuration information from a cloud;
determining, according to the configuration information, whether the at least one function-class module and/or the at least one function sub-module needs to be updated at the client; and
in response to a determination that the at least one function-class module and/or the at least one function sub-module needs to be updated at the client, updating the at least one function-class module and/or at least one function sub-module by using the configuration information.

8. An electronic device, comprising:
a memory storing a computer program thereon; and
a processor for execution of the computer program in the memory to perform:
receiving call parameters comprising a device identification, a device class, and a driving instruction of a target device;
looking up a target function-class module matching the device class in the at least one function-class module according to the device class and a pre-set first mapping relationship, the first mapping relationship being a relationship between the device class supported driving by a client and respective function-class modules;
looking up, by using the target function-class module, a target function sub-module in the at least one function sub-module according to the device identification and a second mapping relationship, the second mapping relationship being a relationship between each function sub-module under the target function-class module and a different device identification; and
sending the driving instruction to the target device via the target function sub-module, to drive the target device to execute a task corresponding to the driving instruction.

9. The electronic device according to claim 8, wherein the looking up a target function sub-module in the at least one function sub-module according to the device identification and a second mapping relationship comprises:
looking up, according to the device identification, a function sub-module matching the device identification in the at least one function sub-module, as the target function sub-module.

10. The electronic device according to claim 8, wherein the client further comprises a host process; the method further comprises: before receiving the call parameters,
activating the host process;
scanning a program directory of the host process and obtaining the at least one function-class module; and
loading the at least one function-class module according to an interface specification and establishing the first mapping relationship, wherein the interface specification is a websocket protocol interface specification.

11. The electronic device according to claim 10, wherein the client further comprises a core daemon process, and the activating the host process comprises:
determining whether a process currently running has a process with the same process name as that of the host process;
in response to a determination that the process currently running has a process with the same process name as that of the host process, closing the running host process, looking up to find a host process file, and activating the host process file; and
in response to a determination that the process currently running does not have a process with the same process name as that of the host process, looking up and activating the host process file.

12. The electronic device according to claim 10, wherein the method further comprises:
determining a function sub-module in each function-class module, and loading each function sub-module;
the determining a function sub-module in each function-class module comprises:
polling each function sub-module;
calling an export function and obtaining a virtual function returned after the export function is called;
determining whether content in the virtual function is the same as a class identified by a current function-class module; and
in response to a determination that the content in the virtual function is the same as a class identified by a current function-class module, determining that the current function sub-module is a function sub-module in the current function-class module.

13. The electronic device according to claim 8, wherein the at least one function-class module comprises a camera-class module, a serial port-class module, and a software management-class module;
the sending a driving instruction to the target device via the target function sub-module, to drive the target device to execute a task corresponding to the driving instruction comprises:
if the target function-class module is a camera module, sending a first driving instruction to a camera via the target function sub-module, the first driving instruction being used for driving the camera to take a picture or record a video;
if the target function-class module is a serial port-class module, sending a second driving instruction to a balance via the target function sub-module, the second driving instruction being used for driving the balance to perform a measurement operation; and
if the target function-class module is a software management-class module, sending a third driving instruction to the operating system via the target function sub-module, the third driving instruction being used for activating a software management function.

14. The electronic device according to claim 8, wherein the method further comprises:
acquiring configuration information from a cloud;
determining, according to the configuration information, whether the at least one function-class module and/or the at least one function sub-module needs to be updated at the client; and
in response to a determination that the at least one function-class module and/or the at least one function sub-module needs to be updated at the client, updating the at least one function-class module and/or at least one function sub-module by using the configuration information.

15. A non-transitory computer readable storage medium having stored computer instructions thereon, which, when executed by a processor, performs:
receiving call parameters comprising a device identification, a device class, and a driving instruction of a target device;
looking up a target function-class module matching the device class in the at least one function-class module according to the device class and a pre-set first mapping relationship, the first mapping relationship being a relationship between the device class supported driving by a client and respective function-class modules;
looking up, by using the target function-class module, a target function sub-module in the at least one function sub-module according to the device identification and a second mapping relationship, the second mapping relationship being a relationship between each function sub-module under the target function-class module and a different device identification; and
sending the driving instruction to the target device via the target function sub-module, to drive the target device to execute a task corresponding to the driving instruction.

16. The non-transitory computer readable storage medium according to claim 15, wherein the looking up a target function sub-module in the at least one function sub-module according to the device identification and a second mapping relationship comprises:
looking up, according to the device identification, a function sub-module matching the device identification in the at least one function sub-module, as the target function sub-module.

17. The non-transitory computer readable storage medium according to claim 15, wherein the client further comprises a host process; the method further comprises: before receiving the call parameters,
activating the host process;
scanning a program directory of the host process and obtaining the at least one function-class module; and
loading the at least one function-class module according to an interface specification and establishing the first mapping relationship, wherein the interface specification is a websocket protocol interface specification.

18. The non-transitory computer readable storage medium according to claim 17, wherein the client further comprises a core daemon process, and the activating the host process comprises:
determining whether a process currently running has a process with the same process name as that of the host process;
in response to a determination that the process currently running has a process with the same process name as that of the host process, closing the running host process, looking up to find a host process file, and activating the host process file; and
in response to a determination that the process currently running does not have a process with the same process name as that of the host process, looking up and activating the host process file.

19. The non-transitory computer readable storage medium according to claim 17, wherein the method further comprises: determining a function sub-module in each function-class module, and loading each function sub-module;
the determining a function sub-module in each function-class module comprises:
polling each function sub-module;
calling an export function and obtaining a virtual function returned after the export function is called;
determining whether content in the virtual function is the same as a class identified by a current function-class module; and
in response to a determination that the content in the virtual function is the same as a class identified by a current function-class module, determining that the current function sub-module is a function sub-module in the current function-class module.

20. The non-transitory computer readable storage medium according to claim 15, wherein the method further comprises:
acquiring configuration information from a cloud;
determining, according to the configuration information, whether the at least one function-class module and/or the at least one function sub-module needs to be updated at the client; and
in response to a determination that the at least one function-class module and/or the at least one function sub-module needs to be updated at the client, updating the at least one function-class module and/or at least one function sub-module by using the configuration information.
